(19) United States
(12) Patent Application Publication
(10) Pub. No.: US 2010/0112892 A1
(43) Pub. Date: May 6, 2010

(54) Doll and pillow case

(76) Inventor: Doreen LaPointe, Hooksett, NH (US)

Correspondence Address: MESMER & DELEAULT, PLLC, 41 BROOK STREET, MANCHESTER, NH, 03104, US

(21) Appl. No.: 12/350,256

(22) Filed: Jan. 8, 2009

Related U.S. Application Data
(60) Provisional application No. 61/109,646, filed on Oct. 30, 2008.

(51) Int. Cl. A63H 3/00; A63H 3/02; A63H 3/36; G09B 19/08; A47C 21/00; A47G 9/10

(52) U.S. Cl. 446/72; 446/369; 446/390; 446/391; 283/45; 5/490; 5/630

(57) ABSTRACT

A stuffed figure and kit for attaching the stuffed figure to a pillow case. The stuffed figure includes a flexible material defining a cavity and configured to depict a body having at least two appendages and a head with a face, a quantity of a soft filler material disposed within the cavity defining a three-dimensional, flexible body, and attaching means disposed at or adjacent each distal end of each of the at least two appendages where the attaching means is configured to removably attach the stuffed figure to a pillow case using the at least two appendages. The kit includes either a pillow case or a literary component or both with characteristics that relate the stuffed figure, the pillow case and the literally component to each other.

This application claims the benefit of U.S. Provisional Patent Application No. 61/109,646, filed Oct. 30, 2008.

### BACKGROUND OF THE INVENTION

1. Field of the Invention

The present invention relates generally to dolls. Particularly, the present invention relates to dolls and pillow cases. More particularly, the present invention relates to rag dolls and pillow cases.

2. Description of the Prior Art

For centuries, rag dolls were made by mothers for their children. Rag dolls refer generically to dolls made of any fabric. Cloth dolls refer to a subset of rag dolls made of linen or cotton. Rag dolls were (and are) functional toys that can be carried around and played with endlessly, patched up, and played with again.

Rag or cloth dolls forever hold a strong affection in adults' and children's hearts and minds having been created & recreated many times over the centuries. The fact that rag dolls were unbreakable and inexpensive resulted in them getting more wear and tear than other, more costly toys, which would have been handled with more care and respect. Thus, there are fewer examples of antique rag dolls in museums and homes today. Those that do survive reflect the fashions and culture of the times. Traditionally, dolls and particularly cloth dolls have been a way of passing cultural norms on to children.

Typically, scraps left over from a diligent sewing session would often lead to a new doll for a deserving child. In fact, it's relatively safe to say that as long as people have been wearing clothing, they've been making rag dolls. Over the years, cloth dolls were stuffed with straw, sawdust, leaves, feathers, fabric scraps, left-over thread and yarn, cotton batting, wood-wool, foam chips, and nylon stockings and more recently polyester filling. Doll clothing was made from fabric scraps left over from the family sewing basket. The clothes would have reflected the clothes of people during the time the dolls were made, including underwear, petticoats, long dress, pinafore, apron and bonnet. Doll shoes and stockings might have been sewn or painted on. Facial features were embroidered or painted with ink or stained with natural dyes from items such as berries, flowers, leaves, tea, and the like. In some cases, e.g. primitive dolls, the dolls might have no face or perhaps were only given eyes. Early dolls were often made from all sorts of materials, such as animal skin, corn husks, cotton fabric and other soft materials.

The pattern/design of the early cloth doll was quite basic, usually consisting of two identically shaped outline body pieces. Sometimes, arms and legs were added to a head/body torso. Today this simple type of doll is called a ‘Pancake Doll’, which describes the flat construction.

Cloth dolls made by Colonial Americans are mentioned in diaries, property lists and literature of the time. Early colonial dolls are also known as “Primitives” or “Pioneer” dolls. In Europe during this time, rag dolls were made for doll houses, as playthings and as adornments for needle cases, made from rolled fabric with drawn on faces. From about the 1850's, commercially produced rag dolls where the dolls were printed on cloth or had their features hand painted in oils became popular.

Flat panel/printed dolls were first sold in sheet form in the early 20^{th} century and were of the outline/pancake style. Man-made fabrics, such as nylon and polyester, were introduced during the early 1950's and in 1955, quick drying polyester filling became available. In the early 1970's, Martha Nelson of Louisville, Ky. created a style of doll using a German folk art known as “needle modeling,” later also known as soft sculpture or needle sculpture. Her style of doll was subsequently copyrighted by Xavier Roberts. These dolls became commercially known as “Cabbage Patch Kids” with vinyl heads, but still maintaining the soft sculptured body. Today cloth dolls are still created all over the world.

Conventional pillows and pillow cases are well known in the art. The conventional pillow and pillow case is generally rectangular in shape. The pillow serves as support for the head during rest and sleep, and is usually made of soft foam, feathers or other natural or synthetic material that provides for comfortable support for the head. The pillow case is usually made of cloth and serves as a cover for receiving the pillow. The cover protects the pillow from becoming dirty and soiled and may be removed from the pillow to allow for easy cleaning.

The pillow case also serves a decorative and aesthetic function such as a comforter, security object and plaything for young children and toddlers.

It is a generally accepted fact that young children adopt an item of bedding, a stuffed doll or animal, or some other soft object as a symbol of the most secure place in their life, their bed. From that symbol they derive a sense of security that they can carry with them to more threatening environments. Only limited attempts have been made to meet this universal need. These attempts include numerous combinations of dolls and pillows, including rag dolls.

U.S. Pat. No. 5,118,318 (1992, Lorizio) discloses a security object system that includes a pillow case with an opening across the back for inserting or removing a pillow and a stylized mother and father rendered on the front of the pillow case. Removable pouches are attached at either end of the pillow case and are dimensioned to receive one each of two dolls. The dolls are stylized to represent a son and daughter bearing family resemblances to the stylized mother and father depicted on the face of the pillow case. Each doll incorporates a suction cup on its back so that it may be fastened to a smooth surface. The clothing for the dolls is removable.

U.S. Pat. No. 4,889,512 (1989, Burnett et al.) discloses a doll and pillow carrying case. Specifically, the device is a combination toy that includes a decorative pillow and a soft sculptural human figure doll. The pillow is provided with a soft filler material housed with a decorative exterior cover. A pocket of essentially the same peripheral measurements as the pillow is permanently attached to both sides and one end and unattached to the pillow end. A handle is attached to the pillow end. An elastic band is attached to the open end of the pocket and serves to engage the doll beneath the armpits for releasable retention. A pair of buttons are also secured to the exterior of the pocket and serve to engage button holes formed in the dress arms of the doll as a further retention element for the doll.

U.S. Pat. No. 3,789,546 (1974, Morrison) discloses a pillow with a hand puppet received in a pocket. The doll and pillow combination includes a baby doll that is removably received on one side of the pillow in a pocket secured to a pillow case. The body portion of the doll is hollow so that a child may place a hand inside the doll and manipulate it in a manner as a puppet.

The disadvantages of the prior art devices include the need for additional holding compartments such as pockets for the dolls and the holding compartments are either permanently attached or removably attached at predefined locations on the pillow case.

Therefore, what is needed is a doll that can be removably attached to a pillow case. What is also needed is a doll and pillow case combination that allows the doll to be attached to the pillow without being restricted to predefined locations on the pillow case.

### SUMMARY OF THE INVENTION

It is an object of the present invention to provide a stuffed figure that can be removably attached to a pillow case. It is another object of the present invention to provide a stuffed figure and pillow case combination where the stuffed figure is capable of attaching to the pillow case without being restricted to a predefined location on the pillow case. It is a further object of the present invention to provide a stuffed figure and pillow case themed combination. It is still another object of the present invention to provide a stuffed figure and a literary component in a themed combination.

The present invention achieves these and other objectives by providing, in one embodiment, a stuffed figure having a flexible material defining a cavity and configured to depict a body having at least two appendages and a head with a face, a quantity of a soft filler material disposed within the cavity defining a three-dimensional, flexible body, and attaching means disposed at or adjacent each distal end of each of the at least two appendages where the attaching means is configured to removably attach the stuffed figure to a structure using the at least two appendages. The attaching means is selected from one of magnets, hook and loop fasteners, snaps, and buttons. When the attaching means are magnets, one magnet is positioned within a cavity portion of each distal end of each of the at least two appendages.

In another embodiment, there is provided a pillow case. The pillow case and the flexible material may optionally include indicia that define a common theme relating the stuffed figure and the pillow case to each other.

In a further embodiment of the present invention, there is provided a literary component containing a literary piece such as a story, poem, etc., relating a common theme with the stuffed figure.

In still another embodiment of the present invention, there is provided a stuffed figure and pillow case kit. The kit includes a pillow case with an open end for receiving a pillow and a stuffed figure having at least two appendages with distal ends where each of the distal ends includes attaching means. The distal ends of the at least two appendages are removably attachable to each other using the attaching means. The attaching means are preferably configured for joining the stuffed FIG. to the pillow case by placing a portion of the pillow case between the distal ends of the at least two appendages. The attaching means is selected from magnets, hook and loop fasteners, snaps, buttons, and the like. The stuffed figure and the pillow case may optionally include indicia that defines and links a common theme between the stuffed figure and the pillow case.

In yet another embodiment of the present invention, there is provided a stuffed figure, a pillow case and a literary component. The literary component contains a name for the stuffed figure and text relating the name, the common theme and the indicia together.

In another embodiment of the present invention, there is provided a stuffed figure kit for use with a pillow case. The kit includes a stuffed figure having at least two appendages with distal ends where each of the distal ends includes attaching means. The distal ends of the at least two appendages are removably attachable to each other and configured for joining the stuffed figure to a pillow case. A portion of the pillow case is placed between the distal ends of the at least two appendages. There is also provided a literary component containing a name for the stuffed figure and text relating the name to indicia on the stuffed figure where the indicia and the text define a common theme.

Another embodiment of the present invention provides a method of retaining a stuffed figure to a pillow case. The method includes disposing attaching means on at least two appendages of the stuffed figure and connecting the at least two appendages to each other with a portion of the pillow case therebetween. The method further includes securing preferably a magnet at each distal end of each of the at least two appendages. The magnets are preferably disposed within the distal ends of each of the at least two appendages. Thereafter, a portion of each of the at least two appendages are sealed adjacent the distal ends entrapping the magnets within each of the distal ends of each of the at least two appendages.

### BRIEF DESCRIPTION OF THE DRAWINGS

FIG. 1 illustrates one embodiment of the present invention showing a front view of the stuffed figure with a pillow case and a literary component.

FIG. 2 is a front view of the embodiment in FIG. 1 showing the stuffed figure connected to the pillow case.

### DETAILED DESCRIPTION OF THE PREFERRED EMBODIMENT

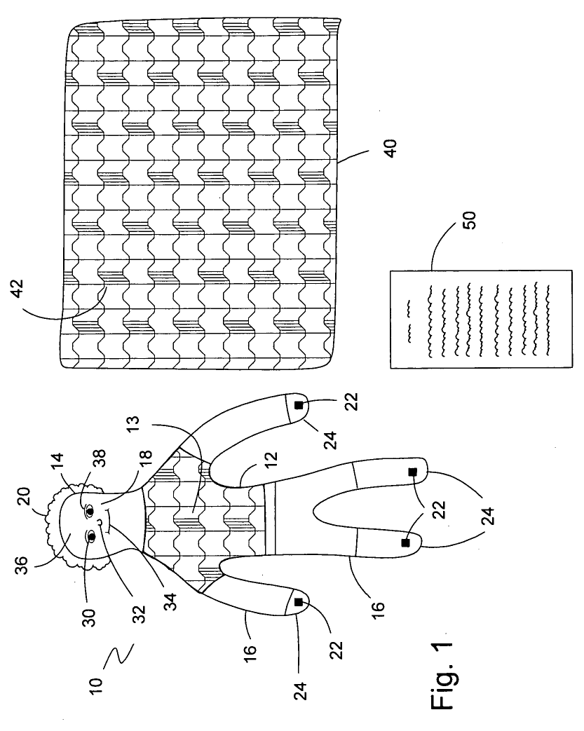

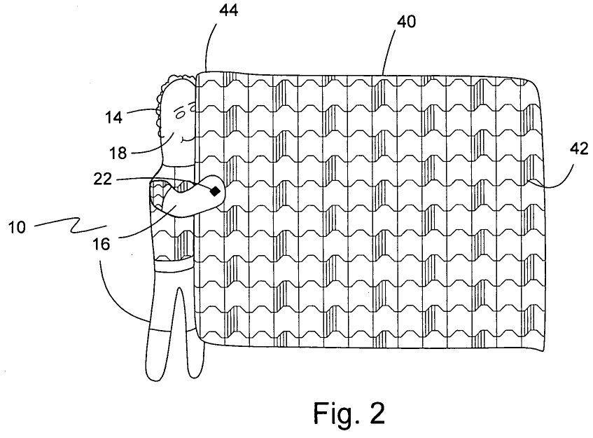

The preferred embodiment(s) of the present invention is illustrated in FIGS. 1-2. FIG. 1 shows one embodiment of a stuffed FIG. 10 of the present invention. Stuffed FIG. 10 may be any soft, stuffed figure such as a stuffed animal, a rag doll, and the like. Stuffed FIG. 10 typically has a body 12 with a head 14 and a plurality of appendages 16. Head 14 may or may not have a face 18 depicted thereon and may optionally include a hair structure 20 extending from head 14. At least two appendages 16 include attachment means 22 disposed at a distal end 24. Attachment means 22 may be selected from magnets, hook and loop fasteners, snaps, buttons, and the like. The preferred attachment means are magnets since no additional modifications are required to be made to a pillow case 40. Body 12 may include indicia 13 or have other accessories with or without indicia 13.

Stuffed FIG. 10 may optionally include accessories such as clothing, hats, shoes, and the like, that defines a particular theme. The themes include, but are not limited to, military, medical, construction, sports, hunting, fishing, car racing, equine-related, farming, fairies, camping, aviation, space/astronomical, demographical, ethnic, and any other category or sub-categories. Stuffed FIG. 10 may be any caricature or animal, is preferably a soft sculpture cloth figure, and more preferably a rag doll. Rag dolls have a unique quality and charm and fulfil a child's deep-rooted need to be comforted. Safety, washability and softness are of paramount importance in their production, while the end result provides a child with emotional security as well as an awareness of the world around them through play and socialization. Rag dolls would seem to be the perfect embodiment of care, safety, love and security.

Materials typically used for making a rag doll include high threat count, 100% woven cotton fabrics such as Primatex and Egyptian cottons, 100% polyester one-way stretch knit such as velour, polyester double knit with a one-way stretch, four-way stretch tricot, 96% cotton with 4% tubular ribbing Lycra, elasticated knitted fabric (also known as cotton jersey knit), etc. The high thread count, 100% woven cotton fabrics are best. It is preferable to choose fabrics with small size prints, checks and plaids so that they fit in with the overall proportions of the doll.

The simplest form of rag/cloth figure is the outline or pancake figure. This type of figure/doll is created simply by cutting the body shape out of a double thickness of fabric, which is then sewn around its perimeter, clipped and turned inside out. Instead of the all-in-one bodies, the body of the figure can also be created by this method to which is added a head, arms, legs, etc. Another type is the stump body doll, which is made without legs and feet. Still another type of body is the gusseted body. This type of body produces a three dimensional shape, which is achieved by the addition of a gusset usually between the two continuous head and body outline pieces. A further type of body is the darted body. This type of body also produces a three dimensional shape, which is achieved by the positioning of darts at the shoulders, hips, sides, and chest. Lastly, there is the seamed or tailored body. This type of body is made up of sections seamed together to create the shape.

The appendages 16 such as legs and/or arms of stuff FIG. 10 may have various embodiments. These embodiments include a stumped appendage, which is footless or handless, whatever the case may be. This is the simplest style to construct. It is made by simply sewing around the shape of the leg or arm. It is possible to give the illusion of a foot or hand by tying around the leg or arm or using different colored material for the foot/hand-part or painting the stump end.

When appendages 16 are legs, another example is the darted leg. By elongating the leg and attaching as by sewing in a dart on the inside ankle and then sewing the outside of the foot against the leg, the stump leg can be transformed into a leg with a foot. Still another example is the pancake foot or boot shaped foot. With this style, the foot can be shaped in many ways and is created by sewing all the way around the leg and foot. Furthermore, the foot may have a separate sole. With this style, the front and back seams of the foot are sewn leaving the bottom open. The sole is then sewn to the bottom of the foot. Inserting an inner piece of card will help to make the sole more rigid. The seamed toe style gives a foot with realistic toes.

When appendages 16 are arms, there can be created the stumped hand, the pleated wrist, the mitten hand, the stitched fingers, separate fingers, inserted wrist and separate hand, and the thumb hand. The stumped hand is similar to the stumped leg described above. The pleated wrist is created by pressing a small pleat in the top layer of fabric for the arm. When turned and stuffed, the hand will turn out at a different angle from the arm. The mitten hand is a simple hand shape with thumb and no fingers. The stitched fingers are like the mitten hand. Only the fingers are top-stitched by hand or machine after the mitten hand is sewn, clipped, turned inside out, and lightly stuffed. The stitched fingers' style gives a hand with realistic fingers. The inserted wrist and separate hand, as the terms imply, combines stump and fingered hand versions. The separate thumb style is a type of hand that involves attaching a separate thumb to the side or palm-side of the hand.

Head 14 like the appendages 16 may have various forms. Head 14 may be an outline head, a ball head, a darted head, a gusseted head, a segmented head, a soft sculpted head, or a seamed head. The outline head style is created by cutting a shape out of a double thickness of fabric. Often the body and head outline are continuous. Sometimes the head and body pieces are separate and the two sides must be sewn at the neck before the front and back of the doll is sewn together around the edge leaving a gap for turning inside out and stuffing. Face 18 is usually shown on one side of the flat surface looking forwards. It is also possible to create a continuous outline of the head following the profile of the forehead, mouth, nose, and chin. Shaped heads can also be made with a row of running stitches around the top, which are drawn together once the head is stuffed.

The ball head is created using a circle of fabric around which a row of gathering stitches are sewn and inside which a clump of stuffing is enclosed, when the threads are drawn up. The darted head is a type of head that produces a three dimensional shape, achieved by inserting darts and sewing across the seam at the chin, the neck and eye level to produce better shape and dimension. The gusseted head produces a three dimensional shape, achieved by the addition of a gusset between the two side head pieces. It is also possible to add a gusset to the chin area to provide a better shape to an outline head. The segmented head produces a three dimensional shape that is achieved by sewing usually three or four sections together. The soft-sculpted head is achieved by building up the shape using layers of filling. This is then covered by a skin of stretch fabric. A seamed head is a way of manipulating the bias of the fabric in a two-dimensional profile head.

Ears can also be created in various ways. These include outline ears, inner seamed ears and separate ears. As the names imply, outline ears are created from a continuous outline of head and ear cut out of a double thickness of fabric. The head outline is then sewn with the ears in position, so that when clipped and turned inside out, the ears will stick out from the sides of head 14. Inner seamed ears are sewn, clipped, turned inside out, and lightly stuffed before being inserted at either side of head 14. Separate ears are made separately and, preferably, hand stitched to head 14 after head 14 has been sewn, turned inside out and stuffed.

It is face 18 that gives stuffed FIG. 10 its individual character. Since face 18, alone, can communicate a stuffed figure's personality, emotion, mood, age and gender, it is potentially the most difficult part to produce. Face 18 can be applied before stuffing and sewing and may look quite different from those applied after stuffed FIG. 10 is sewn and stuffed. The distance between eyes 30, nose 32 and mouth 34 will make a significant difference to the appearance of face 18. Small, close together eyes 32, particularly for humanoid figures, make stuff FIG. 10 look older, while larger eyes 32 are more childlike. Forehead 36, particularly a human forehead, is quite large and the level of the bridge of the nose and tops of ears is actually at the halfway point on face 18. A child's head, on the other hand, is more rounded. The eyes 32 and ears (not shown) are lower down creating a high forehead 36. Eyes 32 are also slightly further apart and larger. A child's eye brows 38 are typically at the midline of face 18.

Applying face 18 can be done by designing it first on a paper template and then transferring it to stuffed FIG. 10. Some heads 14 are sewn in sections resulting in a seam down the middle of face 18 and even a profile nose 32. Other stuffed FIG. 10 have a flat, forward looking face 18.

It is a common misconception that the human eye shape is a symmetrical oval. In fact, the human eye consists of three circular shapes (eyeball, iris and pupil) over which the upper and lower lids rest. Also, unless a person is in shock or fear, the iris and pupil of the eyes are not suspended in the middle of the eyeball, but are eclipsed by the upper eyelids, making the overall eye shape appear oval. When including a white highlight in eye 30, it is important to remember that it is on the same side for both eyes.

While asymmetry can produce some interesting results, symmetry of the facial features creates a pleasing effect. Symmetry can be achieved either by tacking temporary dividing lines onto the stuffed face before applying the features, or by transferring an already symmetrical pencil image from a paper template onto the stuffed figure's face. Simple faces 18 can be achieved by fabric painting, embroidering, sewing, appliques, and needle sculpting.

To give stuffed FIG. 10 its three-dimensional shape, stuffed FIG. 10 is stuffed with a filler material. The filler material usable in stuffed FIG. 10 can be any one or more types of material including, but not limited to, wool batting, sawdust, cotton, straw, hair, feathers, leaves, pieces of fabric, pieces of thread, plastic pellets, beans, sand, polyester fiberfill, and the like. Stuffed FIG. 10 is typically stuffed with the filler material through an opening using various stuffing tools.

In another embodiment of the present invention, a pillow case 40 with indicia 42 that is related to the theme of stuffed FIG. 10 or to indicia 13 or both may optionally be included. In still another embodiment, a literary component 50 may optionally be included that is related to the theme of stuffed FIG. 10. Literary component 50 may be a short story, a poem, a biography, and any other creative, artistic literary piece that relates an interesting aspect of the life, career, hobbies, or other characteristics of stuffed FIG. 10. Preferably, it is whimsical yet a security enhancing feature that provides a child with emotional security as well as an awareness of the world around them through the association of the theme of stuffed FIG. 10.

Turning now to FIG. 2, there is illustrated the unique feature of the present invention. Stuffed FIG. 10 has attaching mechanism 22 fixedly attached to distal end 24 of appendages 16. In the preferred embodiment, attachment mechanism 22 is a magnet entrapped within distal end 24 of two appendages 16. As illustrated, appendages 16 are the arms of stuffed FIG. 10. The pair of appendages 16 containing the magnets attach to each other with an edge portion 44 of pillow case 40 between appendages 16. This configuration keeps stuffed FIG. 10 attached to pillow case 40 while the child sleeps. When the child awakens, stuffed FIG. 10 remains next to the child providing emotional security. This configuration also keeps stuffed FIG. 10 attached to pillow case 40 when the child carries/transports the pillow to which pillow case 40 and stuffed FIG. 10 are attached.

In the preferred embodiment of the present invention, body 12 of stuffed FIG. 10 is preferably made from muslin cloth, cut into pieces for forming hands, legs, body and face, which are sewn together and stuffed with a filler material, preferably polyester fiberfill (i.e. poly fill). Face 18 is preferably stitched, instead of being drawn or applying appliques, before being sewn onto body 12. Pieces cut to form appendage 16 are sewn together forming an arm or leg. Attachment means 22 can be connected to the distal ends 24 of any appendage 16 where distal end 24 is typically considered a hand or hand portion of an arm or a foot or foot portion of a leg. The preferred placement of attachment means 22 is at distal ends 24 that are considered the hands in humanoid figures. Attachment means 22, which preferably is a magnet, is inserted into the distal end 14 of appendage 16. In an area considered to be the wrist on the preferred appendage 16, appendage 16 after receiving the magnet is then sewn across the appendage 16 (i.e. arm) so that the magnet stays (is captured) within the distal end 24 (i.e. hand). The arm is then stuffed with the poly fill. The sewn wrist prevents the stuffing from getting into the distal end 24 (i.e. the hand). By keeping the stuffing out of the hand where the magnet is located, no stuffing can inadvertently get positioned between the magnet and the cloth of appendage 16. Preventing this allows the magnetic force of the magnet to be positioned close enough to pillowcase 40 to attract the magnet in the other appendage 16 and provide a sufficiently strong magnetic field to hold each magnet against each other even with a portion 44 of pillowcase 40 between the two appendages 16. Otherwise, much larger and/or stronger magnets are required to maintain sufficient holding force, which increases the cost of making stuffed FIG. 10. The preferred magnet is a magnetic button manufacture by ProMag Products, Marietta, Ohio and sold under the trademark ProMag® as product no. 600001.

The clothes for stuffed FIG. 10 are made from cotton, satin and fleece material, and each stuffed FIG. 10 comes with a different outfit. Most of the stuffed FIG. 10 have some satin in the outfit as this is very soothing to children. The hair 20 is preferably made from brown, yellow, or black yarn. The yarn hair 20 is sewn on when the body components are sew together. Each different stuffed FIG. 10 has a different outfit and literary component 50, which is a short story. The story is on a folded card that resembles a book. Each stuffed FIG. 10 comes with a themed pillow case 40 preferably made of cotton or flannel. Themed pillow case 40 is printed with indicia 42 (i.e. which has a particular print) that goes along with or is related to the stuffed figure's character.

Stuffed FIG. 10 is preferably given a two word name where one word is the name and the other word relates the character type. Examples of two word names for male stuffed FIG. 10 include, but are not limited to, Jungle Jim, Army Adam, Army Andre, Racer Ryan, Dozer Dan, etc. Jungle Jim is a Tarzan doll whose outfit is a Tarzan print. He comes with a jungle print pillow case 40. Army Adam and Army Andre are army men. They wear camouflage jackets with camouflage pants, and black boots. Army Andre is a black doll made of black broadcloth with black yarn for his hair. Each stuffed FIG. 10 preferably comes with a pillow case 40 that has army trucks and flags printed on it. Racer Ryan is a race car driver and has a red satin jacket with the number 3 on it. He has black satin pants and a black satin helmet with a red stripe. His pillowcase 40 has race cars printed on it. Dozer Dan is a construction worker and wears jeans, a plaid cotton shirt, an orange fleece vest with yellow stripes, and a yellow satin hard hat. His pillow case 40 has construction trucks printed on it.

Examples of stuffed FIG. 10 with female names include, but are not limited to, Brianna Ballerina, Finley Fairy, Hopscotch Hannah, Peaceful Paige, etc. Brianna Ballerina is a ballet dancer who wears a pink satin outfit with a pink tutu and pink satin lace up ballet shoes. Her pillowcase 40 has ballet shoes printed on it. Finley Fairy is a fairy with white satin wings and a purple satin dress. Her pillowcase 40 has fairy wands printed on it. Hopscotch Hannah is a black doll made from black broadcloth. She wears a cotton green dress with flowers and a satin pink rim on the bottom of her dress. She has black yarn corn rolls in a ponytail. Her pillowcase 40 has the numbers 1 through 10 printed on it with blocks. Peaceful Paige is a doll replica of the 1970's wearing bell bottom jeans and a tie dye orange cotton shirt. She has a headband and brown braids made of yarn. Her pillow case 40 has peace signs printed on it.

After making stuffed FIG. 10, attaching stuffed FIG. 10 to the pillow case 40 can be done several ways including using just the hands, hands and feet, or just the feet. An attaching mechanism 22 is incorporated in the hands and/or feet. The attachment mechanism includes hook and loop fastener such as the product sold under the trademark Velcro, snaps, magnets, etc. After experimenting with the various attaching mechanisms, it was determined that the preferred method was to attach only the hands to the pillow case using a magnet in each hand. There are several advantages to this preferred method. The stuffed FIG. 10 could dangle from the pillow when the child carried it. Stuffed FIG. 10 could also stay in place on the pillow case 40 when the child went to bed with stuffed FIG. 10. The hands capture the pillow case 40 between the magnets 22 in each hand as if the hands were grabbing the pillow case 40 as stuffed FIG. 10 lay next to the child. Another advantage of the present invention is for a child to enjoy night time with his or her parents, and go to sleep with the comfort of knowing that the stuffed FIG. 10 (i.e. doll) is attached to the pillow case 40 and will not get lost during the night.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A stuffed figure comprising:
a flexible material defining a cavity and configured to depict a body having at least two appendages and a head with a face;
a quantity of a soft filler material disposed within the cavity defining a three-dimensional, flexible body; and
attaching means disposed at or adjacent each distal end of each of the at least two appendages wherein the attaching means is configured to removably attach the stuffed figure to a structure using the at least two appendages.

2. The stuffed figure of claim 1 wherein the attaching means is selected from one of magnets, hook and loop fasteners, snaps, and buttons.

3. The stuffed figure of claim 2 wherein one of the magnets is positioned within a cavity portion of each distal end of each of the at least two appendages.

4. The stuffed figure of claim 1 further comprising a pillow case.

5. The stuffed figure of claim 4 wherein the pillow case and the flexible material each have indicia defining a common theme relating the stuffed figure and the pillow case to each other.

6. The stuffed figure of claim 5 further comprising a literary component containing text related to the defined common theme.

7. The stuffed figure of claim 4 further comprising a pillow removably received within the pillow case.

8. The stuffed figure of claim 1 wherein each of the at least two appendages are selected from the group consisting of arms and legs.

9. A stuffed figure and pillow case kit comprising:
a pillow case with an open end for receiving a pillow; and
a stuffed figure having at least two appendages with distal ends wherein each of the distal ends includes attaching means, the distal ends of the at least two appendages being removably attachable to each other and configured for joining the stuffed figure to the pillow case by placing a portion of the pillow case between the distal ends of the at least two appendages.

10. The kit of claim 9 wherein the pillow case and the stuffed figure have indicia defining and linking a common theme between the pillow case and the stuffed figure.

11. The kit of claim 9 wherein the attachment means is selected from magnets, hook and loop fasteners, snaps and buttons.

12. The kit of claim 10 further comprising a literary component containing a name for the stuffed figure and text relating the name, the common theme and the indicia together.

13. A stuffed figure kit for use with a pillow case, the kit comprising:
a stuffed figure having at least two appendages with distal ends wherein each of the distal ends includes attaching means, the distal ends of the at least two appendages being removably attachable to each other and configured for joining the stuffed figure to a pillow case by placing a portion of the pillow case between the distal ends of the at least two appendages; and
a literary component containing a name for the stuffed figure and text relating the name to indicia on the stuffed figure wherein the indicia and the text define a common theme between the stuffed figure and the literary component.

14. The kit of claim 13 wherein the attaching means is selected from magnets, hook and loop fasteners, snaps and buttons.

15. The kit of claim 13 further comprising a pillow case with indicia wherein the indicia relates to the common theme expressed between the stuffed figure, the name of the stuffed figure and the text.

16. A method of retaining a stuffed figure to a pillow case, the method comprising:
disposing attaching means on at least two appendages of the stuffed figure; and
connecting the at least two appendages to each other with a portion of the pillow case therebetween.

17. The method of claim 16 wherein the disposing step includes securing a magnet at a distal end of each of the at least two appendages.

18. The method of claim 17 wherein the securing step includes disposing the magnet within each of the at least two appendages and sealing a portion of each of the at least two appendages adjacent the distal end entrapping the magnet within the distal end of each of the at least two appendages.

19. The method of claim 16 further comprising forming the stuffed figure as a rag doll.
